(19) United States
(12) Patent Application Publication
(10) Pub. No.: US 2004/0233544 A1
(43) Pub. Date: Nov. 25, 2004

(54) Apparatus and method for linear correcting

(75) Inventor: Shih-Zheng Kuo, Taipei (TW)

Correspondence Address: LOWE HAUPTMAN GILMAN & BERNER, LLP, Suite 310, 1700 Diagonal Road, Alexandria, VA, 22314, US

(73) Assignee: VEUTRON CORPORATION

(21) Appl. No.: 10/443,074

(22) Filed: May 22, 2003

(51) Int. Cl. G02B 13/00

(52) U.S. Cl. 359/724

(57) ABSTRACT

An image produced through lenses causes distortion problems in the formation of the image. A testing chart having a plurality of lines or graphs is employed to measure the formation of an image through the lens, and correct the linear state of the image. Eigenfunctions may be employed to describe the data of the image. It can reduce the amount of the data describing the linear state of the image.

### BACKGROUND OF THE INVENTION

1. Field of the Invention

This invention relates to a method and an apparatus for linear correcting, and more particularly to employ linear correcting eigenfunctions to correct linear.

2. Description of the Prior Art

In general, an optic apparatus must employ a lens or a reflecting surface for formatting an image. An image capture apparatus (e.g.: a scanner) is one type of the optic apparatus. A light is reflected by an object and then passes through a series of lenses to format an image on a light sensing device, e.g.: charge-coupled device (CCD). Therefore, the quality of the lenses affects the quality of the image formatting.

The lens not only has a chromatic problem, but also has a problem with distortion. Typical types of distortion problems comprise a barrel distortion and a pincushion distortion. In theory, a square image through lenses is still a square image, as shown in FIG. 1A. An image with barrel distortion is where four corners are smaller than the four sides, as shown in FIG. 1B. An image with a pincushion distortion is when the four corners are bigger than the four sides, as shown in FIG. 1C. Due to the distortions, an image with two parallel lines through the lenses is formatted; and the pitch, which is the distance between the two lines, depends on the different places of the captured image.

The ratios of the respective pitches in a captured image are not alike with that of the original image due to distortion. In the common arts, the captured image is not processed by linear correcting for correction in the distortion problems. Due to the quality of the image being entirely determined by the quality of the lenses, the captured image has more or less a distortion problem. The present invention provides an apparatus and a method to efficiently improve the distortion problem in the captured image.

### SUMMARY OF THE INVENTION

In the conventional arts, the image captured by an image capture apparatus has a distortion problem. It is an objective of the present invention to provide a testing chart for measuring a linear state of lenses and calculating the linear function of the lenses.

It is another objective of the present invention, to provide the hardware or software for the linear function of the lenses to immediately correct the linear state of the lenses to efficiently improve the distortion problem.

It is still another objective for present invention to provide eigenfunctions to describe the linear state of the lenses and reduce the amount of the data describing the linear state of the lenses.

As aforementioned, the present invention provides an apparatus and a method for linear correcting. In the present invention, a testing chart is employed to test the linear state of the lenses and then the data describing the linear state of the lenses is saved into a database. A captured image through the lenses is corrected according to the linear state. The linear state of the lenses is described with eigenfunctions to reduce the amount of data. The apparatus and the method for linear correcting can efficiently improve the distortion problems of an image through the lenses.

### BRIEF DESCRIPTION OF THE DRAWINGS

FIG. 1A shows a diagram of a captured square image in theory;

FIG. 1B shows a diagram of a captured square image with a barrel distortion;

FIG. 1C shows a diagram of a captured square image with a pincushion distortion;

FIG. 2A shows a diagram of one preferred embodiment of the present invention;

FIG. 2B shows a diagram of the widths of a ideal pixel and a captured pixel; and

FIG. 3 is a flow chart of the linear correcting process.

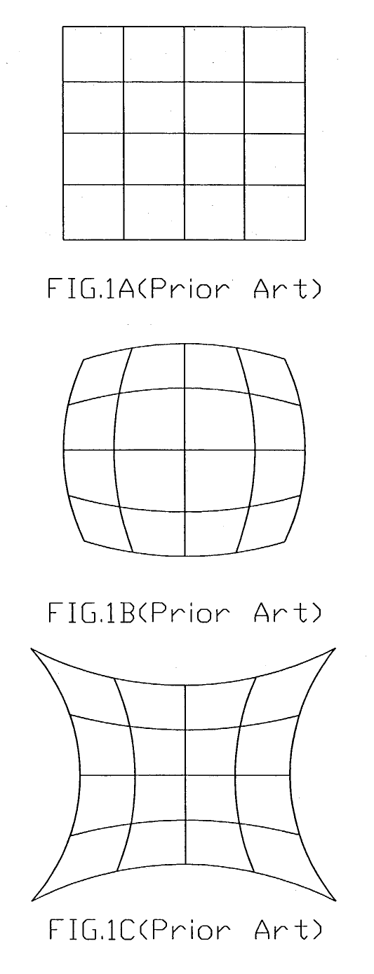

### DESCRIPTION OF THE PREFERRED EMBODIMENT

Some sample embodiments of the invention will now be described in greater detail. Nevertheless, it should be recognized that present invention can be practiced in a wide range of other embodiments besides those explicitly described, and the scope of the present invention is expressly not limited expect as specified in the accompanying claims.

Then, the components of the different elements are not shown to scale. Some dimensions of the related components are exaggerated, and meaningless portions are not drawn. This is done to provide a more clear description and comprehension of the present invention.

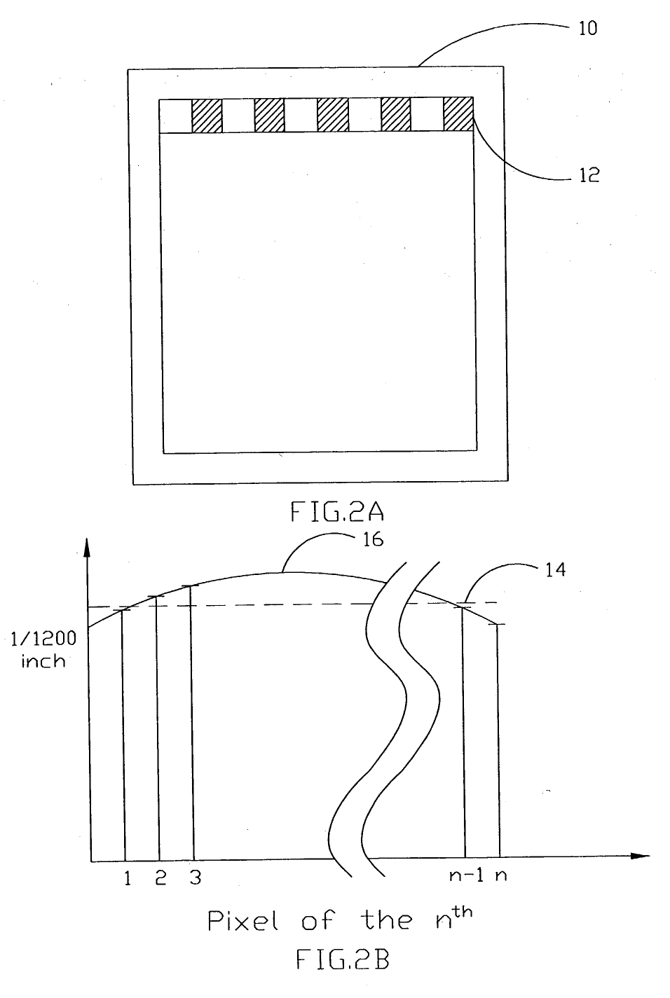

One preferred embodiment of this invention is as shown in FIG. 2A. A testing chart 12 is on a top cover 10 of a scanner for measuring a linear state of lenses in a scanner. The testing chart 12 has lines or patterns with a given pitch or size. A preferred testing chart 12 has squares with the same size and adjacent squares have different colors to easily differentiate the adjacent squares, as shown in FIG. 2A. The number of squares is not limited. A distance between adjacent borders of the adjacent squares is employed to determine a width of a square between the adjacent border.

A scanner captures the image of the testing chart 12. The resolution for scanning is unlimited. A preferred resolution is the highest resolution of the scanner due to the fact that the size of the captured image can be resized by changing the resolution of the scanner. According to the scanner CCD being one dimensional, the linear correction can only be processed in the arranged direction of the CCD in the scanner. For example, the resolution of the scanner is set for 1200 dots per inch (dpi). Therefore, the ideal width captured by each pixel of the CCD is 1/1200 inch. However, the width captured of each pixel is not guaranteed to be 1/1200 inch. Referring to FIG. 2B, the ideal condition is that each pixel of the captured width of line 14 is a total of 1/1200 inch, and if the captured width of each pixel is different as in line 16. The original width in the testing chart captured by each pixel can be obtained according to the width of the square in the testing chart given. For example, the width of each square is 1/12 inch and the resolution of the scanner is 1200 dpi. Therefore, the ideal width of each square in the captured image is the width of 100 pixels. However, a width of a square in the image is the width of 90 pixels. Thus, the average width of a pixel in the square is (100/90)×(1/1200) inch. The captured image can be corrected with the respective width of pixels therein according to the ratio of the ideal width of the respective pixels and the captured width thereof.

The testing chart 12 is divided into n squares and the width of each square is given. The average captured widths of pixels in the respective squares can be obtained according to the image of the captured square having an amount of pixels therein. Yₘ means the average width of a pixel in the m^{th} square and the range of m is 1 to n. Yₘ can be described with eigenvalues of eigenfunctions. The eigenfunctions can be written as

$$\begin{matrix}{Y}_{1} = {A}_{n} {X}_{1}^{n} + {A}_{n - 1} {X}_{1}^{n - 1} + … + {A}_{m} {X}_{1}^{m} + … + {A}_{1} {X}_{1} + {X}_{1}^{0} & ( 1 ) \\ {Y}_{2} = {A}_{n} {X}_{2}^{n} + {A}_{n - 1} {X}_{2}^{n - 1} + … + {A}_{m} {X}_{2}^{m} + … + {A}_{1} {X}_{2} + {X}_{2}^{0} \\ ⋯ & ( 2 ) \\ {Y}_{m} = {A}_{n} {X}_{m}^{n} + {A}_{n - 1} {X}_{m}^{n - 1} + … + {A}_{m} {X}_{m}^{m} + … + {A}_{1} {X}_{m} + {X}_{m}^{0} \\ ⋯ & ( m ) \\ {Y}_{n} = {A}_{n} {X}_{n}^{n} + {A}_{n - 1} {X}_{n}^{n - 1} + … + {A}_{m} {X}_{n}^{m} + … + {A}_{1} {X}_{n} + {X}_{n}^{0} & ( n )\end{matrix}$$

Wherein, A₁ to A₁ is the eigenvalues of the eigenfunctions; X₁ to Xₙ is certain values, e.g. X₁=1, X₂=2, . . . Xₘ=m, Xₙ=n.

The linear state of lenses (or the captured image) can be corrected with the values of Y₁ to Yₙ. The values of Y₁ to Yₙ can be obtained with the eigenvalues of A₁ to Aₙ and the eigenfunctions. The some values between A₁ to Aₙ are equal with each other or are zero and so the amount of the data describing the linear state of the lenses is less than n. Hence, the data saved with the eigenvalues can reduce the amount of data.

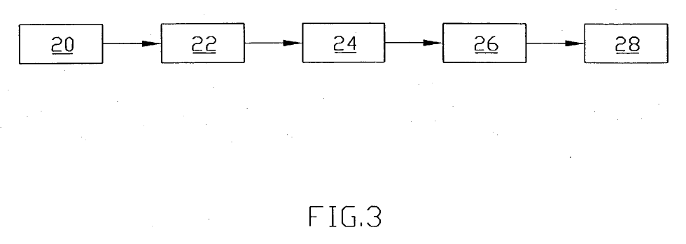

Referring to FIG. 3, it is a flow chart of the linear correcting process. Step 20 is starting. Step 22 is giving the values of A₁ to Aₙ and the values of X₁ to Xₙ into Eq. (1) to Eq. (n). Step 24 is calculating the values of Y₁ to Yₙ. Step 26 is correcting the linear state of the lenses with the values of Y₁ to Yₙ. Wherein preferred values of X₁ to Xₙ are an arithmetic progression, e.g.: 1, 2, 3, . . . X₁ to Xₙ can be created with a loop in a program and so X₁ to Xₙ have no need to extra save in the database. Step 28 is ending.

If the data of the database is the values of Y₁ to Yₙ, not the values of A₁ to Aₙ, step 22 and step 24 can be passed and the values-of Y₁ to Yₙ are directly given into step 26 for correcting the linear state of the lenses.

The linear correcting method is employing the pixel width of the captured image to multiply by the ratio of the ideal width and the captured width, or is other deductive method. The correcting process proceeds with a hardware, e.g.: a linear correcting device in a scanner, or with a software, e.g.: delivering the image data to a personal computer (PC) and correcting the image data with the software setup in the PC.

Hence, the present invention employs a testing chart to measure the linear state of the lenses and to calculate eigenfunctions of the linear state. The hardware or the software with a linear state can be immediately corrected by the linear state eigenfunctions of the lenses. The data of the linear correction can be saved with eigenvalues of eigenfunctions to reduce the amount of the data. Therefore, compared with the common arts, the present invention can employ less data to efficiently improve the distortion of the lenses and increase the reliability and the quality of the captured image.

Although specific embodiments have been illustrated and described, it will be obvious to those skilled in the art that various modifications may be made without departing from what is intended to be limited solely by the appended claims.

What is claimed is:

1. A apparatus for linear correcting in a scanner, comprising:
a testing chart at least comprising a plurality of drawings;
a database comprising an image data of said testing chart through at least one lens and captured by a light sense device; and
a linear correcting device correcting a linear state of said lens according to said image data.

2. The apparatus for linear correcting in a scanner according to claim 1, wherein said image data is captured widths of said image captured by said light sense device with a plurality of light sense units.

3. The apparatus for linear correcting in a scanner according to claim 1, wherein said drawings are lines that the distance between adjacent lines is the same.

4. The apparatus for linear correcting in a scanner according to claim 1, wherein said drawings are graphs that the distance between adjacent graphs is the same.

5. The apparatus for linear correcting in a scanner according to claim 1, wherein colors of adjacent said drawings are different.

6. The apparatus for linear correcting in a scanner according to claim 1, wherein said image data is eigenvalues of a plurality of eigenfunctions describing said linear state of said lens.

7. The apparatus for linear correcting in a scanner according to claim 6, wherein said eigenfunctions are
Yₘ=AₙXₘⁿ+Aₙ₋₁Xₘⁿ⁻¹+ . . . +AₘXₘ^{m}+ . . . +A₁Xₘ+Xₘ⁰
herein the range of m is 1 to n; n is a amount of division in an image through said lens; Yₙ is a average of pixels of said light sense device belong a m^{th} division; Aₙ is a m^{th} eigenvalue of said eigenfunctions; X₁ to Xₙ are predetermined values.

8. The apparatus for linear correcting in a scanner according to claim 6, wherein said image data is selected from the group consisting of A₁ to Aₙ.

9. The apparatus for linear correcting in a scanner according to claim 8, wherein if any term of said A₁ to Aₙ is zero, said database does not comprises said term.

10. A apparatus for linear correcting in a scanner, comprising:
a database comprising an image data of a testing chart through at least one lens and captured by a light sense device;
a captured image data is an image that through said lens and captured by said light sense device; and
a linear correcting device correcting a linear state of said lens according to said image data.

11. The apparatus for linear correcting in a scanner according to claim 10, wherein said linear correcting device is a software.

12. The apparatus for linear correcting in a scanner according to claim 10, wherein said image data is eigenvalues of a plurality of eigenfunctions describing said linear state of said lens.

13. The apparatus for linear correcting in a scanner according to claim 10, wherein said eigenfunctions are
Yₘ=AₙXₘⁿ+Aₙ₋₁Xₘⁿ⁻¹+ . . . +AₘXₘ^{m}+ . . . +A₁Xₘ+Xₘ⁰
herein the range of m is 1 to n; n is a amount of division in an image data through said lens; Yₙ is a average of pixels of said light sense device belong a m^{th} division; An is a m^{th} eigenvalue of said eigenfunctions; X₁ to Xₙ is a predetermined value.

14. The apparatus for linear correcting in a scanner according to claim 13, wherein said image data is selected from the group consisting of A₁ to Aₙ.

15. The apparatus for linear correcting in a scanner according to claim 14, wherein if any term of said A₁ to Aₙ is zero, said database does not comprises said term.

16. A method for linear correcting in a scanner, comprising:
saving an image data through at least one lens and captured by a light sense device; and
correcting an image through said lens captured by said light sense device according to said image data.

17. The method for linear correcting in a scanner according to claim 16, said method further comprising:
employing a testing chart to obtain a data of an image through said lens.

18. The method for linear correcting in a scanner according to claim 17, wherein said image data is eigenvalues of a plurality of eigenfunctions describing said linear state of said lens.

19. The method for linear correcting in a scanner according to claim 17, wherein said eigenfunctions are
Yₘ=AₙXₘⁿ+Aₙ₋₁Xₘⁿ⁻¹+ . . . +AₘXₘ^{m}+ . . . +A₁Xₘ+Xₘ⁰
herein the range of m is 1 to n; n is a amount of division in an image data through said lens; Yₙ is a average of pixels of said light sense device belong a m^{th} division; Aₙ is a m^{th} eigenvalue of said eigenfunctions; X₁ to Xₙ is a predetermined value.

20. The method for linear correcting in a scanner according to claim 18, wherein said image data is selected from the group consisting of A₁ to Aₙ.
